(19) United States
(12) Patent Application Publication
(10) Pub. No.: US 2022/0072978 A1
(43) Pub. Date: Mar. 10, 2022

(54) MULTI-POSITION VEHICLE SEAT

(71) Applicant: FAURECIA AUTOMOTIVE SEATING, LLC, Auburn Hills, MI (US)

(72) Inventors: Robert FITZPATRICK, Holland, MI (US); Rodney GOODRICH, Watervliet, MI (US)

(21) Appl. No.: 17/012,330

(22) Filed: Sep. 4, 2020

(51) Int. Cl. B60N 2/24; B60N 2/01; B60N 2/015; B60N 2/02; B60N 2/06; B60N 2/12; B60N 2/22; B60N 2/30

(52) U.S. Cl. CPC B60N 2/242; B60N 2/01; B60N 2/01525; B60N 2/0292; B60N 2/065; B60N 2002/247; B60N 2/2227; B60N 2/3022; B60N 2/3027; B60N 2/3047; B60N 2002/2204; B60N 2/12

(57) ABSTRACT

A multi-position vehicle seat offers flexible seating arrangements in a vehicle cabin such that passenger capacity of the vehicle can be maximized when desired. The seat has multiple user-supporting configurations so that the larger amount of floor space required by a seated passenger is only used when necessary. The seat can also be configured to fit multiple user heights and to have a conformable seating surface to comfortably accommodate different user sizes and preferences.

### TECHNICAL FIELD

The present disclosure relates to vehicle seats and, in particular, to vehicle seats with movable components.

### BACKGROUND

Shuttle vehicles are used to transport small groups of people from place to place. Larger than a personal automobile but smaller than a train or full-size bus, shuttles can efficiently transport people in a flexible manner since they are not necessarily tied to a particular route like a train, they are small enough to use public roads and maneuver through traffic, yet they can accommodate many more people than other vehicles on public roads. The efficiency of a shuttle is related to the maximum number of people the shuttle can accommodate. Most shuttles include seats, which are desirable for passengers who wish to sit or perhaps are unable to stand for an entire journey. Seats are also used when the shuttle is at only a fraction of its maximum capacity. But seats take up valuable square footage in the shuttle cabin and reduce its maximum capacity compared to a cabin in which all people are standing.

U.S. Pat. No. 5,364,151 to Yurasits discloses a seat for use in the operator cabin of a utility vehicle such as a refuse hauler or forklift. The seat has a conventional seating position with a horizontal seat bottom and vertical seat back and converts to a spaced-forward vertical support for the operator to lean against when operating the vehicle while standing. The convertible seat of Yurasits occupies the same amount of floor space in the operator cabin in both positions.

### SUMMARY

In accordance with one or more embodiments, a vehicle seat includes a back support and a stowable hip support interconnected by an upholstery sheet that provides a conformable seating surface for supporting a user when the hip support is in a sitting position.

In some embodiments, the hip support has a perch position between the sitting position and a stowed position.

In some embodiments, the hip support pivots about a pivot axis during movement toward or away from the sitting position.

In some embodiments, an end of the upholstery sheet is attached to the back support and an opposite end of the upholstery sheet is attached to the hip support away from the pivot axis.

In some embodiments, the hip support extends horizontally in the sitting position and vertically when stowed.

In some embodiments, the vehicle seat includes a spool around which the upholstery sheet is collected when the hip support is stowed and from which the upholstery sheet is extended when the hip support is moved to the sitting position.

In some embodiments, a spool around which the upholstery sheet is collected when the hip support is stowed is attached to the hip support.

In some embodiments, the upholstery sheet is retractable about a spool around which the upholstery sheet is collected when the hip support is stowed.

In some embodiments, the upholstery sheet is folded when the hip support is stowed and unfolded when the hip support is in the sitting position.

In some embodiments, the hip support is vertically adjustable along a frame.

In some embodiments, the hip support and the back support are vertically adjustable along a frame independently from each other.

In some embodiments, the hip support and the back support are together vertically adjustable along a frame.

In some embodiments, the vehicle seat includes a head rest that is adjustable relative to the back support.

In some embodiments, the back support is attached to a frame by an arm such that a storage area is defined between the back support and the frame with the arm forming a bottom of the storage area.

In some embodiments, a vehicle includes a plurality of vehicle seats each having a back support and a stowable hip support interconnected by an upholstery sheet that provides a conformable seating surface for supporting a user when the hip support is in a sitting position.

Various aspects, embodiments, examples, features and alternatives set forth in the preceding paragraphs, in the claims, and/or in the following description and drawings may be taken independently or in any combination thereof. For example, features disclosed in connection with one embodiment are applicable to all embodiments in the absence of incompatibility of features.

### BRIEF DESCRIPTION OF THE DRAWINGS

Exemplary embodiments will hereinafter be described in conjunction with the appended drawings, wherein like designations denote like elements, and wherein:

FIG. 1 is a cutaway view of a shuttle passenger cabin with an embodiment of a multi-position seat in a sitting configuration;

FIG. 2 illustrates the seat of FIG. 1 changed to a perch configuration;

FIG. 3 illustrates the seat of FIGS. 1 and 2 changed to a standing configuration;

FIG. 4 is a side view of a multi-position seat with a hip support in a stowed position;

FIG. 5 illustrates the hip support of FIG. 4 in a perch position;

FIG. 6 illustrates the hip support of FIGS. 4 and 5 in a sitting position;

FIG. 7 is a side view of a multi-position seat in which the hip support and back support are independently adjustable;

FIG. 8 is a side view of a multi-position seat in which the hip support and back support are adjustable together;

FIG. 9 is an isometric view of a multi-position seat with the hip support in the sitting position; and

FIG. 10 illustrates the hip support of FIG. 9 in the stowed position.

### DETAILED DESCRIPTION

Described below are embodiments of a multi-position vehicle seat that offers flexible seating arrangements in a vehicle cabin such that passenger capacity of the vehicle can be maximized when desired. The seat has multiple user-supporting configurations so that the larger amount of floor space required by a seated passenger is only used when necessary. The seat can also be configured to fit multiple user heights and to have a conformable seating surface to comfortably accommodate different user sizes and preferences.

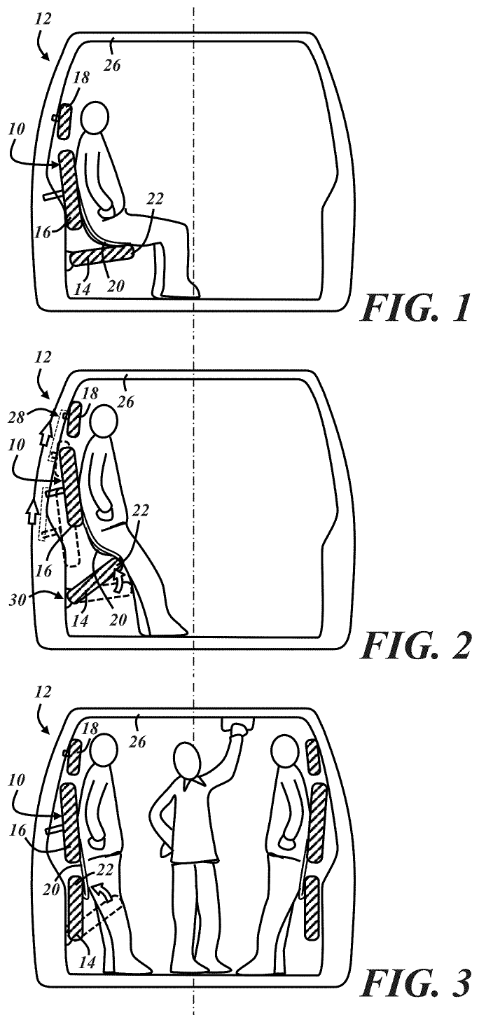

FIGS. 1-3 illustrate an example of a multi-position vehicle seat 10 installed in the passenger cabin of a vehicle 12. The vehicle 12 is a shuttle, and each of FIGS. 1-3 is a cutaway view from a longitudinal end of the passenger cabin. The illustrated seat 10 includes multiple movable components, including a hip support 14, a back support 16, and a headrest 18. The hip support 14 and back support 16 are interconnected by an upholstery sheet 20 that provides a conformable seating surface at least in a sitting configuration of the seat 10, as illustrated in FIG. 1. The sitting configuration is intended to permit a user to be in a conventional sitting position, where the seat 10 is supporting most if not all of the weight of the user. In this configuration, a free or forward end 22 of the hip support 14 is at its maximum horizontal distance from the back support 16 to provide a sufficiently large area for a person to sit with their hips and torso over the hip support with the end 22 of the hip support along the back of their thighs. The hip support 14 is in a sitting position when the seat 10 is in the sitting configuration of FIG. 1 and extends horizontally, which is any angle of less than 30 degrees from horizontal, as used herein.

In FIG. 2, the seat 10 is in a perch configuration which is intended to permit the user take some of their own weight off their feet to be supported by the seat 10. In this configuration, the forward end 22 of the hip support 14 is not horizontally spaced as far from the back support 16 as in the sitting configuration of FIG. 1. The center of gravity of the user may be closer to being directly over the end 22 of the hip support 14 in the perch configuration than in the sitting configuration. The hip support 14 is in a perch position when the seat 10 is in the perch configuration and extends at an angle greater than that of the sitting position of the hip support with respect to horizontal. In the example of FIG. 2, the hip support 14 extends at an angle of approximately 35 degrees from horizontal, but the angle may be smaller or larger. The hip support 14 may have multiple perch positions between the sitting position of FIG. 1 and a stowed position (FIG. 3). The seat 10 occupies less floor space in the perch configuration than in the sitting configuration, as does the user, whose legs are closer to vertical than to horizontal. The upholstery sheet 20 may also provide a conformable support surface in the perch configuration, as shown in FIG. 2. The perch configuration enables the user to be in an exit-ready position to quickly leave the vehicle without as much effort as rising from a seated position. In some embodiments, an angled or high friction footrest or vehicle floor may be provided to help the user stay in place in the perch configuration while the vehicle is moving.

In FIG. 3, the seat 10 is in a standing configuration which is intended to minimize the floor space occupied by the seat while still providing support surfaces against which the user can lean during use. In this configuration, the forward end 22 of the hip support 14 is at its smallest horizontal distance from the back support 16, or at least at less of a horizontal distance than in the sitting and perch configurations. The hip support 14 is in a stowed position when the seat 10 is in the standing configuration and extends vertically, which is any angle of less than 30 degrees from vertical, as used herein. The seat 10 occupies less floor space in the standing configuration than in the sitting and perch configurations, as does the user, who is standing upright. Depending on the particular seat construction, the upholstery sheet 20 may provide a conformable support surface in the standing configuration. In the example of FIG. 3, the upholstery sheet 20 is folded in the standing configuration. The vehicle 12 of FIG. 3 is shown with a plurality of the multi-position seats 10 facing each other in the passenger cabin.

Each of the hip support 14, back support 16, and headrest 18 is movably joined to a support frame 26. In this case, the support frame 26 is integral with a wall of the vehicle body. In other embodiments, the frame 26 is part of the seat 10 that holds the other seat components together as an assembly that can be affixed in the interior of the vehicle 12. FIG. 2 shows the sitting configuration of the seat 10 in broken lines, and movement of the hip and back supports 14, 16 and headrest 18 relative to the sitting configuration is indicated with outline arrows. Similarly, FIG. 3 shows the perch position of the hip support 14 in broken lines, and movement of the hip support relative to the perch position is indicated with an outline arrow.

In the illustrated embodiment, the back support 16 and headrest 18 are coupled with the support frame 26 by sliding joints 28, while the hip support 14 is coupled to the support frame by a pivot joint 30 (see FIG. 3). The sliding joints 28 permit linear movement of the respective components along the frame 26, making the back support 16 and headrest 18 vertically adjustable. The pivot joint 30 permits rotations of the hip support 14 about a pivot axis. The linear movement of the back support 16 and headrest 18 is generally parallel with the wall of the vehicle body in this example. The sliding joints 28 are illustrated only schematically in FIG. 2 as T-slotted joints, for example, in which a post extending from the moveable component moves along a slot in the support frame 26.

The joints 28 are not shown in detail here, as there are several suitable types of joints that permit movement of the back support 16 and headrest 18 along the frame 26. Non-limiting examples include linear bushings, four-bar linkages, telescopic joints, and joints that facilitate powered movement, such as hydraulic cylinders and motorized power screws. In some examples, the back support 16 is moveable along the frame, and the headrest 18 is coupled directly with the back support. The back support 16 and headrest 18 can move together, and the headrest 18 can be moveably coupled with the back support 16. In some cases, the headrest 18 is integral with the back support as one-piece, or the headrest may be omitted altogether. The vertical location of the hip support 14 may also be adjustable along the frame 26.

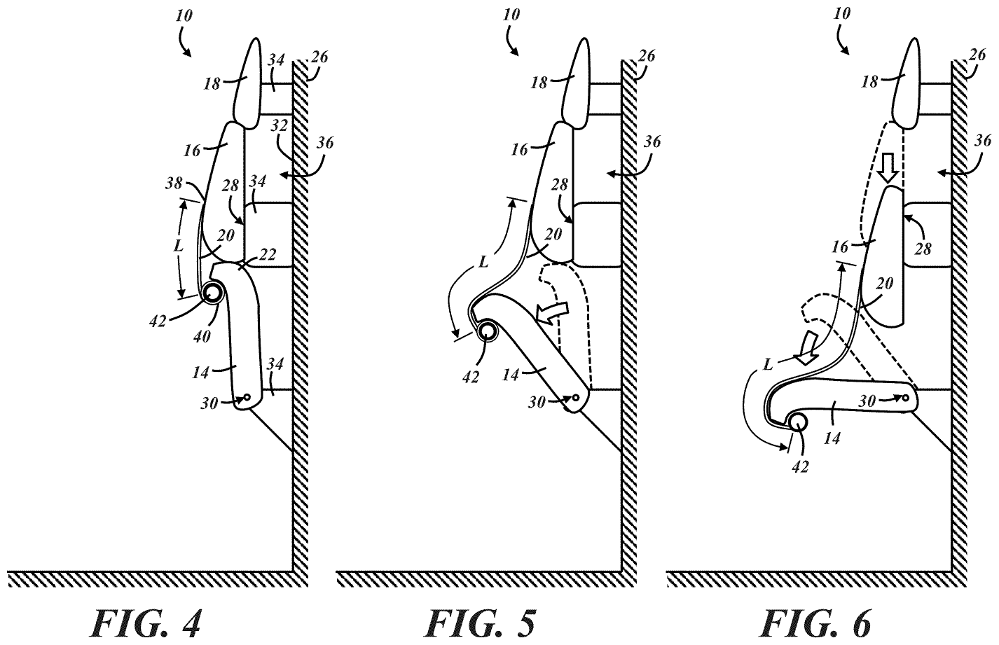

FIGS. 4-6 are enlarged side views of the multi-position seat 10 mounted along the support frame 26. Here, the seat 10 is shown in the standing configuration in FIG. 4, changed to the perch configuration in FIG. 5, and to the sitting configuration in FIG. 6. The frame includes an upright 32 and brackets or arms 34 that extend from the upright to space the hip support 14, back support 16, and headrest 18 from the upright. In this particular example, the sliding joint 28 associated with the back support 16 is located along an end of one of the arms 34 extending from the upright 32. A space 36 is defined between the back support 16 and the upright 32 and between the arms 34 associated with the back support and the headrest 18. This space 36 can be used as a storage space for the user to stow personal belongings during transport. The space 36 is accessible from the left and right sides of the seat or by moving the back support 16 along the frame 26 as shown in FIG. 6.

A first end 38 of the upholstery sheet 20 is attached to the back support 16, and an opposite second end 40 of the upholstery sheet is attached to the hip support 14 at a location away from the joint 30. In this case, the seat 10 includes a spool 42 about which a portion of the upholstery sheet 20 is collected when the hip support 14 is in the stowed position, as in FIG. 4. An extended portion of the upholstery sheet 20 has a length (L) that increases as the hip support 14 moves from the stowed position of FIG. 4 to the sitting position of FIG. 6. The spool 42 may be spring-loaded or otherwise configured to make the upholstery sheet 20 retractable about the spool when the hip support is moved toward the stowed position of FIG. 4 from a different position.

The first end 38 may be permanently attached to the back support 16 (e.g., by sewing) such that at least some of the upholstery sheet 20 is always extended from the spool 42, or detachable (e.g., by hook-and-loop fasteners) such that the entire length of the upholstery sheet can be stored on the spool. In other embodiments, the spool 42 may be located within or along the back support 16 with the opposite end of the upholstery sheet 20 at a fixed location along the hip support 14, or the upholstery sheet may be retractable at both ends. The upholstery sheet 20 may be considered in its retracted condition when the hip support 14 is in the stowed position as in FIG. 4, in a partially extended condition when the hip support is in the perch position as in FIG. 5, and in a fully extended condition when the hip support is in the sitting position of FIG. 6.

The upholstery sheet 20 includes or is a layer of fabric, such as leather, vinyl, woven or knit natural or synthetic fibers, elastic netting, etc. The upholstery sheet 20 has a thickness that may be uniform along its length and width, and the thickness is its smallest dimension (e.g., 0.5 mm to 2.0 mm. The upholstery sheet 20 is characterized by a high in-plane tensile strength and tensile modulus but little to no resistance to out-of-plane deformation. These characteristics make it conformable to the shape of the user's body while still able to support a portion of the user's weight. In one example, the upholstery sheet 20 is formed from the same material as a trim covering of the back support 16 and/or the headrest 18. The back support 16 and headrest 18 may for example include a foam cushion covered by an upholstery sheet.

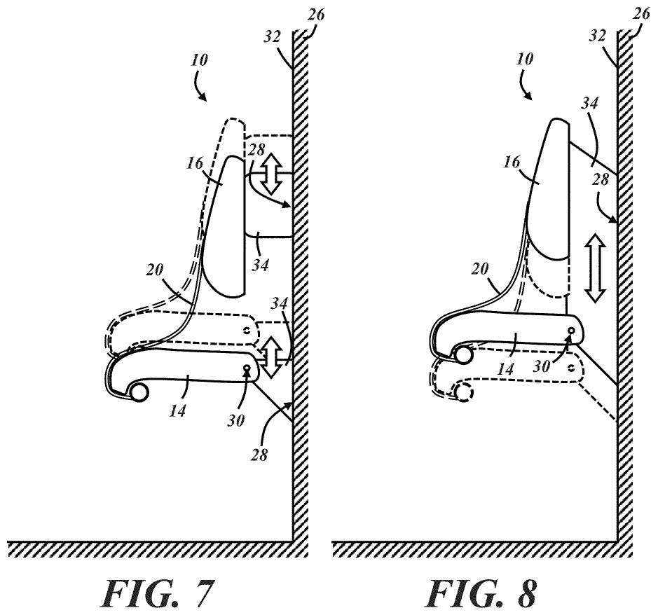

FIGS. 7 and 8 illustrate configurations of the multi-position seat 10 in which the hip support 14 and the back support 16 are movably joined to the support frame 26 by sliding joints 28. In the example of FIG. 7, the supports 14, 16 are independently moveable via separate sliding joints 28. Each support 14, 16 is coupled with the upright 32 by a separate bracket 34, with the sliding joints 28 being formed between the respective brackets 34 and the upright 32. In the example of FIG. 8, the supports 14, 16 move together via a single sliding joint 28 between a single bracket 34 and the upright 32 of the support frame 26. In this example, the seat 10 may include another joint between the back support 16 and the respective bracket 34 to permit independent vertical adjustment of the back support 16. The illustrated movements and joints are merely exemplary. Any of the hip support 14, the back support 16, or the optional headrest 18 may be moveable with respect to the support frame in other or non-linear directions. For example, the back support 16 and/or headrest 18 may be configured to tilt to suit user comfort.

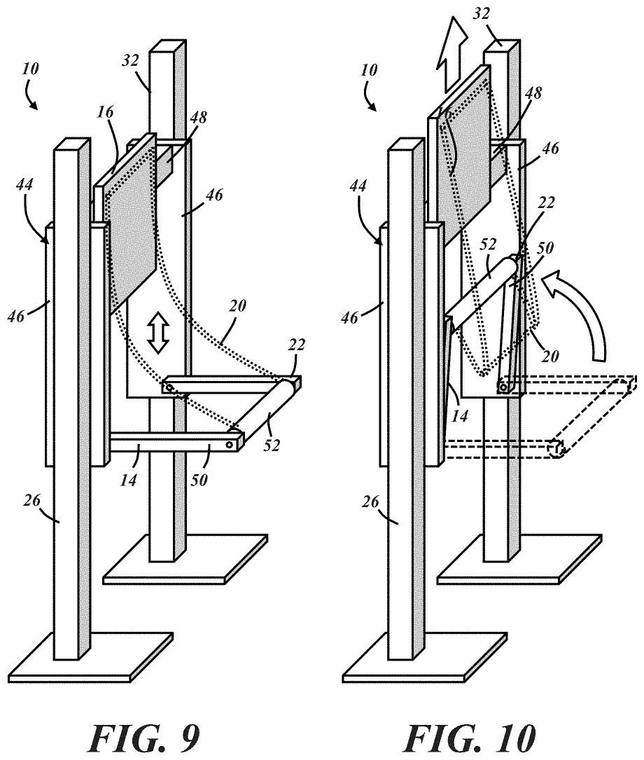

FIGS. 9 and 10 illustrate an example of the multi-position seat 10 in which the support frame 26 is part of the seat. The upholstery sheet 20 is shown in broken lines and cushion and trim elements are omitted so that the underlying structure is more easily visible. The support frame 26 includes a transversely spaced pair of uprights 32 and a carrier or subframe 44 affixed between the uprights via sliding joints that permit translational movement of the subframe along the uprights in the vertical direction. The subframe 44 includes its own pair of uprights 46 and an upper crossmember 48 spanning the uprights 46. Transversely spaced pivot arms 50 of the hip support 14 are attached to respective uprights 46 of the subframe 44 and interconnected by a lower crossmember 52 that forms the free end 22 of the hip support. The illustrated lower crossmember 52 of the hip support 14 is cylindrical and pivotably attached at its opposite ends to the pivot arms 50. The back support 16 is movably attached to the upper crossmember 48 of the subframe 44 for vertical movement relative to the subframe.

FIG. 9 illustrates the hip support 14 in the sitting position, and FIG. 10 illustrates the hip support in the stowed position. Depending on the overall height of the back support 16, it may be moved vertically upward as shown in FIG. 10 to make room for the hip support 14 to be fully stowed. Or the back support 16 may be adjusted vertically upward to provide a higher support surface for taller individuals leaning against the seat 10 in the standing position. The upholstery sheet 20 is folded when the hip support 14 is stowed as in FIG. 10 and unfolded when the hip support is in the sitting position as in FIG. 9. In some embodiments, the lower crossmember 52 of the hip support 14 is a spool 42 similar to that of FIGS. 4-6 so that the upholstery sheet 20 is retractable.

An intermediate perch configuration is not illustrated in this example, but the hip support 14 may be moved and locked into a perch position at one or more angles between the horizontal sitting position and the vertical stowed position as in the examples of FIGS. 1-6. The hip support 14 may require more robust lock-in-place mechanisms than the back support 16 since the hip support 14 must support a larger portion of the user's weight and since the direction of movement of the hip support is at times in line with the applied user load. The seat 10 may include a mechanical stop the prevents the hip support 14 from moving beyond the horizontal orientation of the sitting position, for example, and a retractable pin or similar latch may secure the hip support in the perch position(s). Similar robust lock or latches may be used to secure the vertical position of the subframe 44 along the uprights 46 in this example, or the vertical position of the brackets 34 supporting the hip support 14 in the examples of FIGS. 7 and 8.

It is to be understood that the foregoing is a description of one or more preferred exemplary embodiments of the invention. The invention is not limited to the particular embodiment(s) disclosed herein, but rather is defined solely by the claims below. Furthermore, the statements contained in the foregoing description relate to particular embodiments and are not to be construed as limitations on the scope of the invention or on the definition of terms used in the claims, except where a term or phrase is expressly defined above. Various other embodiments and various changes and modifications to the disclosed embodiment(s) will become apparent to those skilled in the art. All such other embodiments, changes, and modifications are intended to come within the scope of the appended claims.

As used in this specification and claims, the terms “for example,” “for instance,” “such as,” and “like,” and the verbs “comprising,” “having,” “including,” and their other verb forms, when used in conjunction with a listing of one or more components or other items, are each to be construed as open-ended, meaning that that the listing is not to be considered as excluding other, additional components or items. Other terms are to be construed using their broadest reasonable meaning unless they are used in a context that requires a different interpretation.

1. A vehicle seat, comprising a back support and a stowable hip support interconnected by an upholstery sheet that provides a conformable seating surface for supporting a user when the hip support is in a sitting position.

2. The vehicle seat of claim 1, wherein the hip support has a perch position between the sitting position and a stowed position.

3. The vehicle seat of claim 1, wherein the hip support pivots about a pivot axis during movement toward or away from the sitting position.

4. The vehicle seat of claim 3, wherein an end of the upholstery sheet is attached to the back support and an opposite end of the upholstery sheet is attached to the hip support away from the pivot axis.

5. The vehicle seat of claim 3, wherein the hip support extends horizontally in the sitting position and vertically when stowed.

6. The vehicle seat of claim 1, further comprising a spool around which the upholstery sheet is collected when the hip support is stowed and from which the upholstery sheet is extended when the hip support is moved to the sitting position.

7. The vehicle seat of claim 6, wherein the spool is attached to the hip support.

8. The vehicle seat of claim 6, wherein the upholstery sheet is retractable about the spool.

9. The vehicle seat of claim 1, wherein the upholstery sheet is folded when the hip support is stowed and unfolded when the hip support is in the sitting position.

10. The vehicle seat of claim 1, wherein the hip support is vertically adjustable along a frame.

11. The vehicle seat of claim 1, wherein the hip support and the back support are vertically adjustable along a frame independently from each other.

12. The vehicle seat of claim 1, wherein the hip support and the back support are together vertically adjustable along a frame.

13. The vehicle seat of claim 1, further comprising a head rest that is adjustable relative to the back support.

14. The vehicle seat of claim 1, wherein the back support is attached to a frame by an arm such that a storage area is defined between the back support and the frame with the arm forming a bottom of the storage area.

15. A vehicle comprising a plurality of vehicle seats as defined in claim 1.
